(19) United States
(12) Patent Application Publication
(10) Pub. No.: US 2008/0129017 A1
(43) Pub. Date: Jun. 5, 2008

(54) SEAT RECLINING APPARATUS FOR VEHICLE

(75) Inventors: Hiroyuki OKAZAKI, Chiryu-shi (JP); Masaki Sugimoto, Anjo-shi (JP); Yukifumi Yamada, Toyota-shi (JP)

Correspondence Address: OBLON, SPIVAK, MCCLELLAND MAIER & NEUSTADT, P.C., 1940 DUKE STREET, ALEXANDRIA, VA, 22314, US

(73) Assignee: AISIN SEIKI KABUSHIKI KAISHA, Kariya-shi (JP)

(21) Appl. No.: 11/941,383

(22) Filed: Nov. 16, 2007

(30) Foreign Application Priority Data
Dec. 5, 2006 (JP) 2006-328394

(51) Int. Cl. B60N 2/72

(52) U.S. Cl. 280/727

(57) ABSTRACT

A seat reclining apparatus for a vehicle, includes a rail member, a slider, a lock apparatus, a striker, a rotating member provided between the rail member and the slider and including a large diameter portion and a small diameter portion, the large diameter portion engaging the rail member along a longitudinal direction of the rail member, and the small diameter portion engaging the slider along a longitudinal direction of the rail member and the striker adapted to engage a lock member attached to the seat back in order to maintain an angle of the seat back.

### CROSS REFERENCE TO RELATED APPLICATIONS

This application is based on and claims priority under 35 U.S.C. § 119 to Japanese Patent Application 2006-328394, filed on Dec. 5, 2006, the entire content of which is incorporated herein by reference.

### FIELD OF THE INVENTION

The present invention relates to a seat reclining apparatus for a vehicle.

### BACKGROUND

A seat reclining apparatus for a vehicle disclosed in JP2003312329A includes a rail member, a slider, a lock apparatus and a striker. The rail member is attached to a vehicle body and is formed in a circular arc shape to be aligned along a curve described by the seat back upon its reclining operation, the slider is engaged with the rail member so as to be slidable thereon, the lock apparatus regulates/permits the slider sliding on the rail member, and the striker is fixed on the slider. In this configuration, an angle of the seat back is maintained when the striker is engaged with a lock member attached to the seat back.

According to the seat reclining apparatus disclosed in JP2003312329A, a sliding friction is generated between the rail member and the slider on which the rail member slides. The sliding friction is generally generated when two solid surfaces slide against each other. The level of the sliding friction is relatively large, so that the slider may not smoothly slide on the rail member. In addition, in order to stabilize the actuation of the slider sliding on the rail member, each of the rail member and the slider may be formed with high dimensional accuracy.

Further, in order to reduce the sliding friction between the rail member and the slider, a rotating member, which is formed in a column shape or a sphere shape, may be provided between the rail member and the slider. In this case, a level of the friction generated when the rotating member rotates between the rail member and the slider is 10% of the abovementioned sliding friction.

When the rotating member is provided between the slider and the rail member, the slider moves within a certain moving distance, and the rotating member moves relative to the slider in a half of the moving distance of the slider. Accordingly, when the moving distance of the slider relative to the rail member needs to be extended, the length of the slider needs to be extended in a moving direction thereof. In this case, the size of the slider is increased.

Furthermore, when plural rotating members are provided so as to be spaced in a moving direction of the slider, each rotating member needs to be located so as to be distanced from each end of the slider, so that the rotating members are located to be close each other. In this case, even when two rotating members are provided between the slider and the rail member, the slider is practically supported by the rail member at approximate one point, as a result, a posture and an actuation of the slider are unstable.

A need exists or a seat reclining apparatus which is not susceptible to the drawback mentioned above.

### SUMMARY OF THE INVENTION

According to an aspect of the present invention, a seat reclining apparatus for a vehicle, includes a rail member formed in a straight shape and adapted to be attached to the vehicle so as to be aligned approximately along a curve described by a pivotal movement of a seat back, a slider attached to the rail member so as to be slidable, a lock apparatus for regulating/permitting the slider to slide on the rail member, a striker formed so as to include a first end portion, a second end portion and a connecting portion connecting the first end portion to the second end portion, the first end portion and the second end portion being connected to the slider, and a rotating member provided between the rail member and the slider and including a large diameter portion and a small diameter portion, the large diameter portion engaging the rail member along a longitudinal direction of the rail member, and the small diameter portion engaging the slider along a longitudinal direction of the rail member; wherein the striker adapted to engage a lock member attached to the seat back in order to maintain an angle of the seat back.

### BRIEF DESCRIPTION OF THE DRAWINGS

The foregoing and additional features and characteristics of the present invention will become more apparent from the following detailed description considered with reference to the accompanying drawings, wherein:

FIG. 1 illustrates a side view schematically indicating a vehicle seat;

FIG. 2 illustrates a front view indicating a striker apparatus related to a first embodiment of the present invention;

FIG. 3 illustrates a cross section of the striker apparatus along III-III line in FIG. 2;

FIG. 4 illustrates a cross section of the striker apparatus along IV-IV line in FIG. 2;

FIG. 5 illustrates an enlarged view indicating the striker apparatus illustrated in FIG. 4;

FIG. 6 illustrates a front view indicating a striker apparatus related to a second embodiment of the present invention;

FIG. 7 illustrates a bottom view indicating the striker apparatus of the second embodiment; and

FIG. 8 illustrates a side view indicating the striker apparatus of the second embodiment.

### DETAILED DESCRIPTION

### First Embodiment

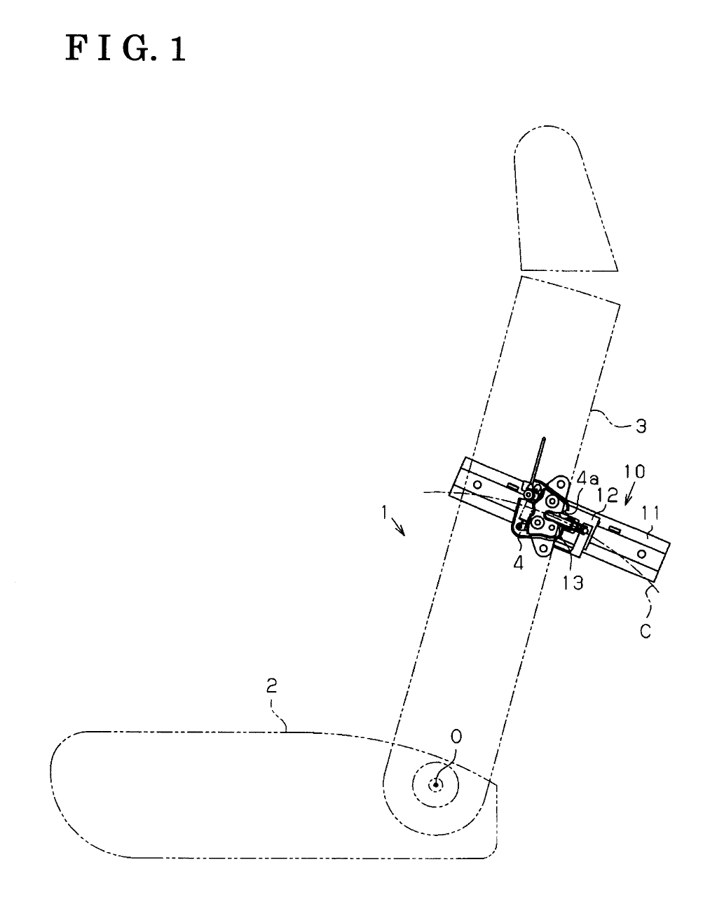

An embodiment of the present invention will be explained in accordance with the attached drawings. FIG. 1 illustrates a side view schematically indicating a vehicle seat 1 to which the present invention applies. The vehicle seat 1 is mounted to a rear compartment of a vehicle such as an automobile. As illustrated in FIG. 1, the vehicle seat 1 includes a seat cushion 2 forming a seating surface of the vehicle seat 1 and a seat back frame 3 supported by the seat cushion 2 at a rear end portion thereof so as to be pivotable relative to a pivotal axis O. The seat back frame 3 forms a bone structure of the seat back.

Further, a lock member 4 is attached to the seat back frame 3. The lock member 4 is formed in an approximate U-shape, specifically, a recessed portion 4a is formed so that the lock member 4 is formed in the approximate U-shape having an upper portion and a lower portion. The lock member 4 is moved together with the seat back frame 3 with describing a curve C when the seat back frame 3 pivots relative to the pivotal axis O.

On the other hand, a rail member 11, which is formed in a straight shape, is attached to a vehicle body so as to be aligned along the tilting movement of the seat back. In other words, the rail member 11 is attached to a vehicle body at a central portion of the curve C described by the lock member 4 so as to extend in a tangential line direction of the curve C. A slider 12 is attached to the rail member 11 so as to be slidable thereon, and a striker 13 is connected to the slider 12 so as to face the recessed portion 4a of the lock member 4. The rail member 11, the slider 12 and the striker 13 configure a striker apparatus 10. While the slide of the slider 12 on the rail member 11 is limited, a first end of the striker 13 is inserted into the recessed portion 4a of the lock member 4, and the striker 13 is prevented from coming off from the recessed portion 4a by means of a latch mechanism (not shown) provided at the lock member 4, so that an angle of the seat back (seat back frame 3) can be maintained. The angle of the seat back frame 3 may be adjusted by changing the position of the slider 12 relative to the rail member 11.

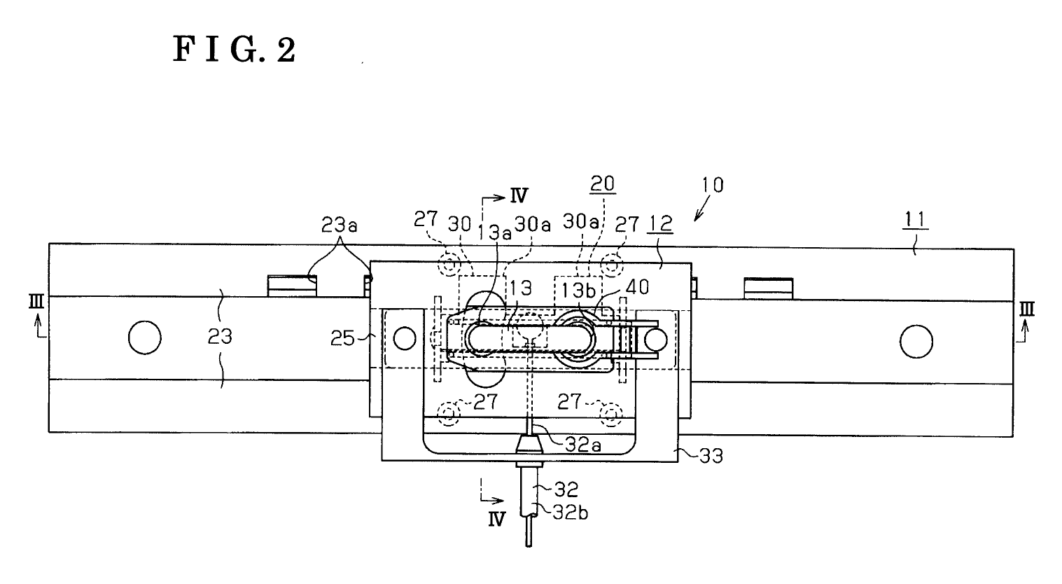

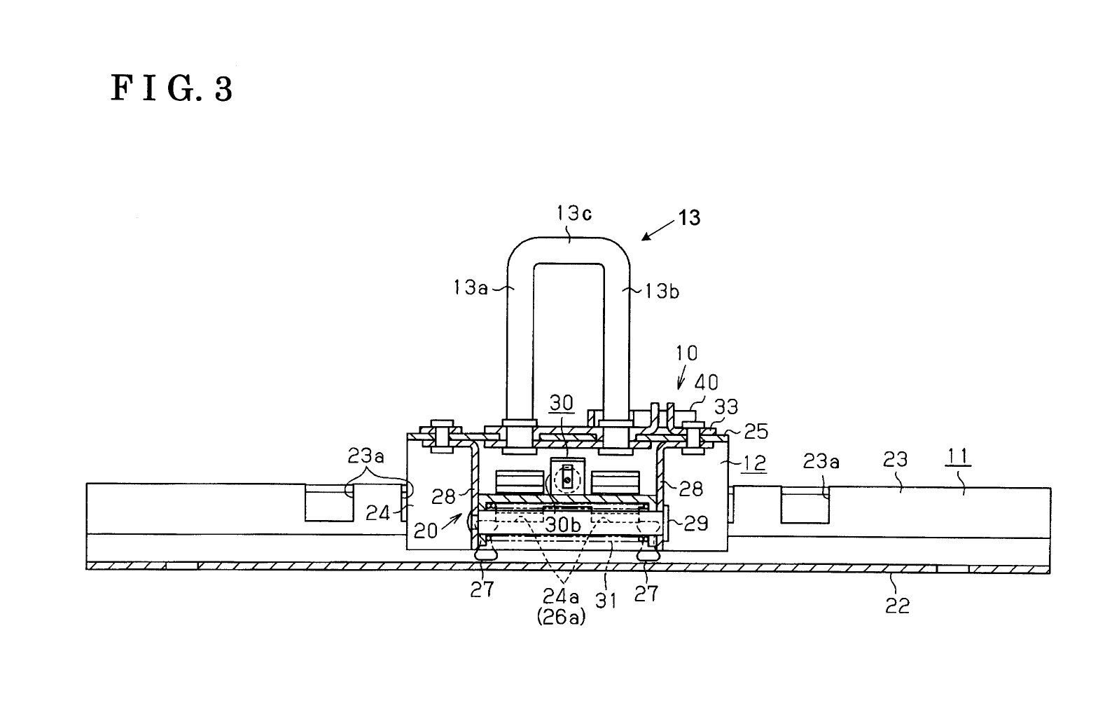

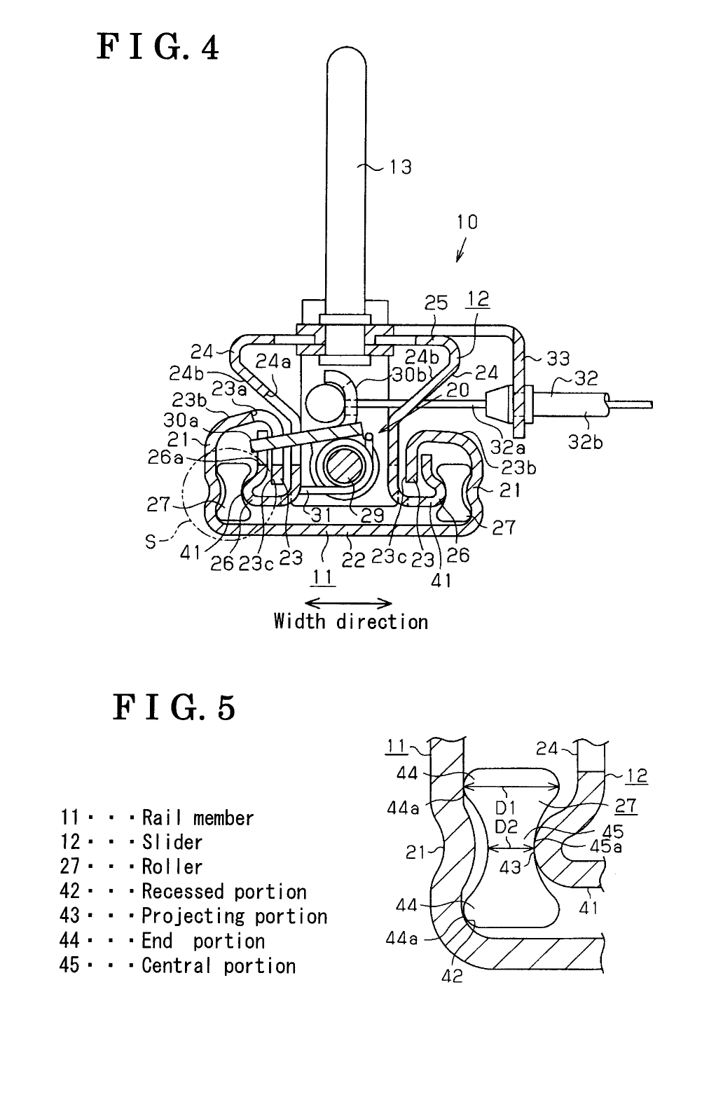

The striker apparatus 10 will be further explained in accordance to FIGS. 2 through 4. FIG. 2 illustrates a front view indicating the striker apparatus 10, FIG. 3 illustrates a cross section of the striker apparatus 10 along a III-III line, and FIG. 4 illustrates a cross section of the striker apparatus 10 along a IV-IV line.

As illustrated in FIG. 4, the rail member 11 is made of a plate material that basically includes two side wall portions 21, each serving as a side surface portion, facing each other and a bottom portion 22, serving as a vehicle side attaching surface, connecting one of the side wall portions 21 to the other of the side wall portions 21 at lower ends thereof. Further, a fold portion 23 is continuously formed from each upper end of the side wall portions 21 so as to extend toward the lower end of each side wall portion 21. Specifically, each fold portion 23 includes an inclined surface 23b, serving as an inclined surface, and a vertical wall portion 23c, serving as a vertical surface portion. The inclined surface 23b is formed so as to extend inwardly from an upper end of the side wall portion 21, and the vertical wall portion 23c is formed so as to extend vertically toward the bottom portion 22 from an end of the inclined surface 23b. The rail member 11 formed in the straight line shape thus includes a U-shape constant cross section. The rail member 11 is fixed to the vehicle body at the bottom portion 22 thereof by means of fastening.

On the other hand, the slider 12 is made of a plate material and basically formed so as to include a pair of side wall portions 24 facing each other and a top portion 25, serving as a striker attaching surface, connecting the side wall portions 24 at each upper end thereof. The top portion 25 is arranged so as to be parallel with the bottom portion 22. When the slider 12 engages the rail member 11, the slider 12 is positioned in a manner where the pair of side wall portions 24 extend between the fold portions 23 of the rail member 11. The side wall portions 24 are bent inwardly at lower portions thereof so that a distance between the side wall portions 24 at each lower portion thereof is narrower than a distance between the side wall portions 24 at each upper portion thereof. Further a fold portion 26 is formed at each lower end of the side wall portion 24 in a manner where it is bent outwardly and extend upwardly so as to enclose each fold portion 23 of the rail member 11 when the slide 12 engages the rail member 11. Specifically, each side wall portion 24 includes a slider inclined surface 24b, serving as a slider inclined surface, formed so as to extend vertically and inwardly from each end of the top portion 25 with forming an acute angle between the side wall portion 24 and the top portion 25. Further, each wall portion 24 includes a U-shaped portion 41 at each lower end thereof extending so as to enclose the vertical wall portion 23c together with the fold portion 26.

Because the slider 12 engages the rail member 11 in a manner where the fold portions 26 engage the fold portions 23, the slider 12 is prevented from moving in a vertical direction relative to the bottom portion 22 of the rail member 11. As shown in FIG. 4, four rollers 27 each formed in an hourglass-shape are provided between each of the fold portions 26 and the side wall portions 21. Each roller 27 serves as a rotating member and includes a large diameter portion at each end thereof and a small diameter portion between the large diameter portions. Specifically, each two of the rollers 27 are provided in a longitudinal direction of the slider 12 as illustrated in FIG. 3. Each roller 27 is located in a manner where a rotational axis thereof corresponds to a direction that is perpendicular with the bottom portion 22. Directions of the rotational axes of the rollers 27 are identical. Thus, the slider 12 is supported by the rail member 11 so as to be slidable in a longitudinal direction of the rail member 11 (in a direction of the tangential line of the curve C) in a manner where the rollers 27 are rotated therebetween.

On one of the fold portions 23 of the rail member 11, a plurality of lock holes 23a are formed so as to be arranged in a longitudinal direction of the rail member 11. Each of the lock holes 23a is formed in a square shape and is spaced equally from each other. In this embodiment, as illustrated in FIGS. 2, 3 and 4, six lock holes 23a are formed on the left fold portion 23 of the rail member 11.

Further, on one of the side wall portions 24 of the slider 12, a plurality of through holes 24a are formed so as to be arranged in a longitudinal direction of the slider 12. Each of the through holes 24a is equally spaced from each other so as to correspond with the lock holes 23a being adjacent to each other in a longitudinal direction of the rail member 11. In this embodiment, as illustrated in FIGS. 2, 3 and 4, two through holes 24a are formed on the left side wall portion 24 of the slider 12 and arranged so as to correspond with two of the lock holes 23 being adjacent to each other in a longitudinal direction of the rail member 11.

Further, on the one of the fold portions 26 of the slider 12, a plurality of notch portions 26a is formed so as to be arranged in a longitudinal direction of the slider 12. Each of the notch portions 26a is equally spaced from each other so as to correspond with the lock holes 23a being adjacent to each other. In this embodiment, as illustrated in FIGS. 3 and 4, two notch portions 26a are formed on the left hold portion 26 of the slider 12 so as to correspond with two lock holes 23a being adjacent to each other.

As illustrated in FIG. 3, two supporting brackets 28 are provided so as to be distanced in a longitudinal direction of the slider 12 and sandwich the two through holes 24a therebetween, and the two supporting brackets 28 are tightened to the top portion 25 of the slider 12. A lock lever 30 is supported by the supporting brackets 28 via a lock lever pin 29.

As illustrated in FIGS. 2 and 4, plural protruding portions 30a are formed on the lock lever 30. In this embodiment, two protruding portions 30a are formed on the lock lever 30 as illustrated in FIG. 2. Specifically, the protruding portions 30a are formed outwardly so as to face the through holes 24a and the notch portion 26a and so as to be distanced in a longitudinal direction.

Each protruding portion 30a of the lock lever 30 is positioned so as to be inserted into/removed from the through hole 24a and the notch portion 26a in accordance with the rotation of the lock lever 30 relative to the lock lever pin 29. In this configuration, when the lock lever 30 is rotated and each protruding portion 30a is inserted into the through hole 24a, the lock hole 23a and the notch portion 26a, the slider 12 is limited so as not to slide on the rail member 11, and further, the position of the striker 13, which is connected to the slider 12, is determined.

On the other hand, when the lock lever 30 is returned and each protruding portion 30a is removed from the notch portion 26a, the lock hole 23a and the through hole 24a, the slider 12 is allowed so as to slide on the rail member 11.

Further, a spring 31 is attached to the supporting brackets 28 by means of the lock lever pin 29. Specifically, one end of the spring 31 is engaged with one of the supporting brackets 28 and one end of the lock lever, and the other end of the spring 31 is engaged with the other of the supporting brackets 28 and the other end of the lock lever 30. In this configuration, the lock lever 30 is continuously biased in a manner where each protruding portion 30a is inserted into the through hole 24a.

Further, as illustrated in FIG. 3, an attachment piece 30b is formed between the protruding portions 30a so as to extend toward the top portion 25. As illustrated in FIGS. 2 and 4, one end of an internal wire 32a of a double pipe structured cable 32 is engaged with the attachment piece 30b, and an external wire 32b of the cable 32 is fixed to a cable bracket 33, which is tightened to the top portion 25 of the slider 12 together with the two supporting brackets 28. The other end of the internal wire 32a is connected to a release handle (not shown), and when the internal wire 32a is pulled outwardly by operating the release handle, the lock lever 30 is rotated against the biasing force applied thereto by the spring 31 so that each protruding portion 30a of the lock lever 30 is removed from the through hole 24a.

Thus, the lock holes 23a, the lock lever 30 and a surrounding structure thereof, all of which function in order to regulate/permit the slider 12 to slide on the rail member 11, comprise the lock apparatus 20. As illustrated in FIG. 3, the striker 13 is made of a round rod and formed in an approximate inverted U-shape having two corners so as to include a connecting portion 13c, a first end portion 13a and a second end portion 13b. Specifically, the connecting portion 13c connects an upper end of the first end portion 13a to an upper end of the second end portion 13b, and lower end portions of the first end portion 13a and the second end portion 13b are connected to the top portion 25 of the slider 12. Specifically, the striker 13 is connected to the top portion 25 in a manner where the second end portion 13b is rotatably connected to the top portion 25, and the first end portion 13a, which is adapted to be engaged with the lock member 4, is connected to the top portion 25 so as to pivot relative to the second portion 13b.

Furthermore, the striker apparatus 10 further include a torsion spring 40. The torsion spring 40 applies a force to the striker 13 so that the first end portion 13a adapted to rotate relative to the second end portion 13b on the slider 12 (top portion 25) is returned to its original position at which an imaginary line connecting the first end portion 13a and the second end portion 13b is identical with a longitudinal direction of the rail member 11 (see FIG. 2).

Next, the roller 27 and its surrounding structure will be explained. FIG. 5 illustrates an enlarged diagram indicating an area enclosed by a circle S illustrated in FIG. 4. As illustrated in FIG. 5, each side wall portion 21 vertically extending from the bottom portion 22 includes a recessed portion 42 at a corner formed between the side wall portion 21 and the bottom portion 22 in a manner where the corner is chamfer in its cross section.

On the other hand, each U-shaped portion 41 includes a projecting portion 43 formed at a corner of the U-shaped portion 41 so as to project toward the recessed portion 42, the corner facing the side wall portion 21 of the rail member 11. The roller 27 is formed so as to include two end portions 44 and a small diameter portion 45 provided between the end portions 44. Each large diameter portion 44 have a diameter that is larger than a diameter of the small diameter portion 45 in a rotational axis of the roller 27. The roller 27 is retained between the rail member 11 and the slider 12 in a manner where one of the large diameter portion 44 contacts the recessed portion 42, the other of the large diameter portions 44 contacts the side wall portion 21 at the side of the openings of the rail member, and the small diameter portion 45 contacts the projecting portion 43.

When a moving distance of the slider 12 sliding on the rail member 11 is set to L, a maximum diameter of each large diameter portion 44 is set to D1, and a minimum diameter of the small diameter portion 45 is set D2, a moving distance L1 of the roller 27 rotating relative to the slider 12 is calculated by a formula: L1=L×D2/(D1+D2). By setting a ratio between the D1 and D2 to be larger, the moving distance L1 of the roller 27 relative to the slider 12 can be set to be relatively smaller.

Further, each large diameter portion 44 includes a first curved surface 44a, and the small diameter portion 45 includes a second curved surface 45a. The curvature radius of the recessed portion 42 is set to R1, and the curvature radius of the first curved surface 44a is set to R2. The curvature radius R1 is set to be larger than the curvature radius R2. Furthermore, the curvature radius of the projecting portion 43 is set to R3, and the curvature radius of the second curved surface 45a is set to R4. The curvature radius R3 is set to be smaller than the curvature radius R4.

In this configuration, the roller 27 is retained between the slider 12 and the rail member 11 so as not to be misaligned in an axial direction of the roller 27 by means of the large diameter portion 44 and the recessed portion 42 curved toward the large diameter portion 44 relative to the contacting portion between the large diameter portion 44 and the recessed portion 42. Further, the roller 27 is retained between the slider 12 and the rail member 11 so as not to be misaligned in an axial direction of the roller 27 by means of the projecting portion 43 and the small diameter portion 45 curved toward the projecting portion 43 relative to the contacting portion between the small diameter portion 45 and the projecting portion 43.

As illustrated in FIG. 4, the recessed portions 42 are provided in a width direction of the rail member 11 so as to face each other, and the projecting portions 43 are provided in a width direction of the slider 12 so as to face each other. Thus, each roller 27 is retained between the recessed portion 42 and the projecting portion 43 with pushing each other in the width directions of the rail member 11 and the slider 12. As a result, the rollers 27 are retained so as not to be misaligned in a width direction of the rail member 11 (or the slider 12).

In this configuration, the position of the striker 13 is adjusted by adjusting the position of the slider 12, which is regulated/permitted to slide on the rail member 11 by means of the lock apparatus 20. The angle of the seat back frame 3 relative to the pivotal axis O is adjusted by adjusting the position of the striker 13 engaging with the lock member 4.

When the lock member 4 attached to the seat back frame 3 is engaged with the striker 13, a gap is generated between the lock member 4 and the striker 13, the lock member 4 adapted to pivot relative to the pivotal axis O in accordance with the tilt of the seat back frame 3 (seat back) and the striker 13 adapted to move along with the rail member 11. This gap (a gap in a radial direction of the rotation of the lock member 4) is adjusted by the pivotal movement of the first end portion 13a. Further, once the first end portion 13a is disengaged from the lock member 4, the first end portion 13a is moved to its original position by means of the biasing force applied by the torsional spring 40.

When the striker 13 is disengaged from the lock member 4, the seat back frame 3 can be pivoted relative to the pivotal axis O without interference with the striker apparatus 10 and other surrounding members.

According to the first embodiment, because the hourglass shaped roller 27 is provided between the rail member 11 and the slider 12, only a friction resistance caused by the rolling resistance is generated by the roller 27, as a result, the slider 12 may smoothly slide on the rail member 11. Further, the moving distance L1 of the roller 27 relative to the slider 12 when the roller 27 is rotated is set so as to be sufficiently smaller than the moving distance L of the slider 12 sliding on the rail member 11. Thus, the slider 12 may be downsized, at the same time, the moving distance L of the slider 12 relative to the rail member 11 may be set to be larger without dropping the roller 27.

Because the moving distance L1 of the roller 27 relative to the slider 12 when the roller 27 is rotated is set so as to be sufficiently smaller, the rollers 27 provided in a moving direction of the slider 12 may be distanced. Thus, the slider 12 may be stably supported by the rail member 11 by means of the rollers 27 provided so as to be distanced in a moving direction of the slider 12.

According to the first embodiment, each roller 27 is retained so as not to be misaligned in an axial direction thereof by means of the large diameter portion 44 and the recessed portion 42 curved toward the large diameter portion 44 relative to the contacting portion between the large diameter portion 44 and the recessed portion 42. Further, because the curvature radius R1 of the recessed portion 42 is set so as to be larger than the curvature radius R2 of the first curve surface 44a, the actuation of the roller 27 rotating on the recessed portion 41 at the large diameter portion 44 thereof may not be interrupted. At the same time, each roller 27 is retained so as not to be misaligned by means of the projecting portion 43 and the small diameter portion 45 curved toward the projecting portion 43 relative to the contacting portion between the small diameter portion 45 and the projecting portion 43. Further, because the curvature radius R3 of the projecting portion 43 is set so as to be smaller than the curvature radius R4 of the second curved surface 45a, the actuation of the roller 27 rotating on the projecting portion 43 at the small diameter portion 45 thereof may not be interrupted.

According to the first embodiment, the rollers 27 provided in a width direction of the rail member 11 is retained between the recessed portion 42 and the projecting portion 43 with pushing each other in the width direction of the rail member 11. As a result, the rollers 27 are retained so as not to be misaligned in a width direction of the rail member 11 (or the slider 12).

According to the embodiment, the rail member 11 may simply be formed in a straight shape.

### Second Embodiment

A second embodiment will be explained in accordance with the attached drawings. Explanations of some configurations identical to the first embodiment will be omitted here.

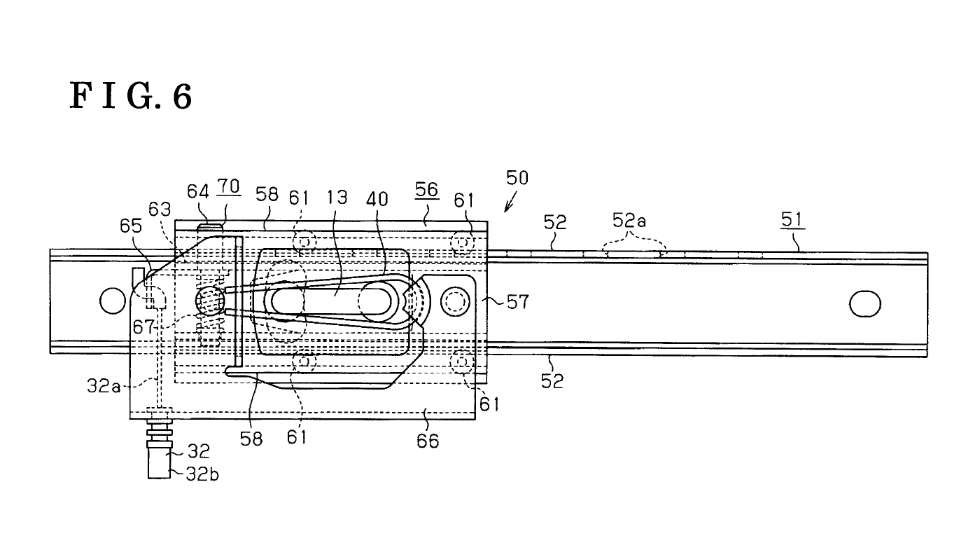

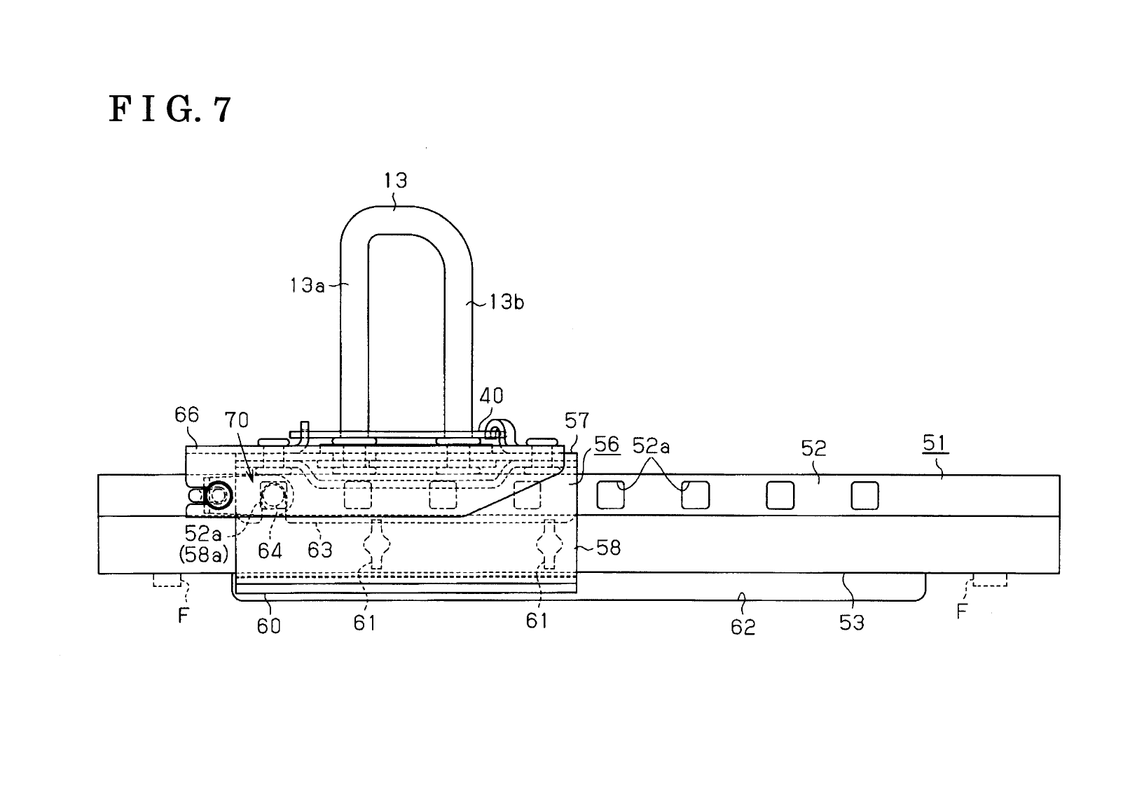

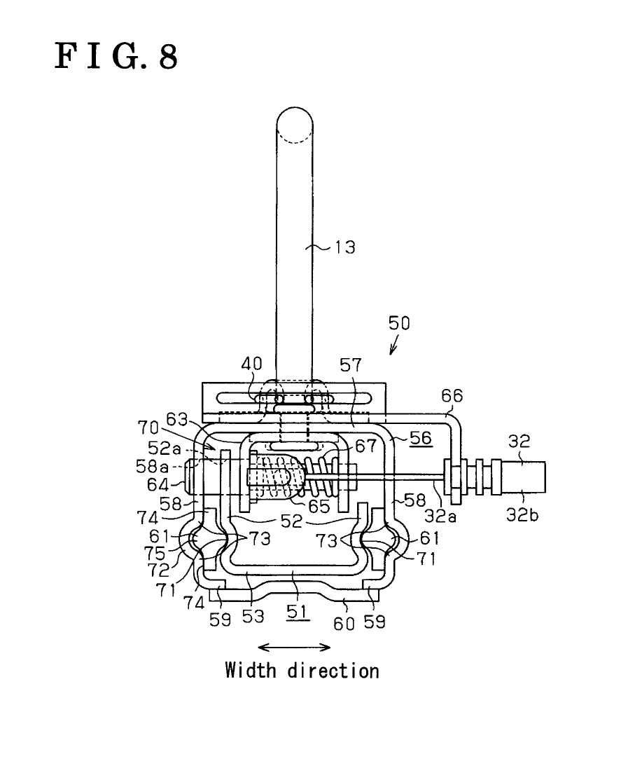

FIG. 6 illustrates a front view of a striker apparatus 50, FIG. 7 illustrates a bottom plan view of the striker apparatus 50, and FIG. 8 illustrates a side view of the striker apparatus 50. As illustrated in FIG. 8, the striker apparatus 50 includes a rail member 51 and a slider 56. The rail member 51 is made of a plate material so as to form an approximate C-shape in its cross section. Specifically, as illustrated in FIG. 8, which indicates a cross sectional view of the striker apparatus 50, the rail member 51 includes two side wall portions 52 and a bottom wall portion 53, serving as a vehicle side attaching surface. One of the side wall portions 52 is formed so as to extend upwardly from one end of the bottom wall portion 53, and the other of the side wall portions 52 is formed so as to extend upwardly from the other end of the bottom wall portion 53. In other words, the bottom wall portion 53 is provided so as to connect one side wall portion 52 to the other wall portion 52 at each bottom end thereof. The rail member 51 is fixed to the vehicle body by screwing in a manner where the bottom wall portion 53 is fixed to attaching portions F (indicated in FIG. 7) of the vehicle body.

The slider 56 made of a plate material includes a top portion 57, serving as a striker attaching surface, two slider side wall portions 58, two flat portions 59 and a slider fixing member 60 as illustrated in the cross section of FIG. 8. Specifically the top portion 57 serving as a striker attaching surface is arranged so as to be in parallel with the bottom wall portion 53. In this configuration, the striker 13 is connected to the top portion 57. One of the slider side wall portions 58 is formed so as to extend from one end of the top portion 57, and the other of the slider side wall portions 58 is formed so as to extend from the other end of the top portion 57. One of the flat portions 59 is formed so as to extend inwardly from the one of the slider side wall portions 58, and the other of the flat portions 59 is formed so as to extend inwardly from the other of the slider side wall portion 58. The slider fixing member 60 is provided so as to connect flat portions 59. In this configuration, the slider 56 is formed so as to have a rectangular cross section. Further, as illustrated in FIG. 8, because the rail member 51 is provided so as to be enclosed by the slider 56 in its cross section, the rail member 51 may only be removed in a longitudinal direction of the rail member 51.

The slider 56 engages each side wall portion 52, which faces the slider 56, via a roller 61. The roller 61 is formed in an approximate diamond shape in its cross section and serves as a rotating member. As illustrated in FIG. 7, two rollers 61 are provided so as to be distanced in a longitudinal direction of the slider 56. Each of the rollers 61 is provided parallel each other in its axial direction in a manner where each axis is perpendicular to the bottom wall portion 53. The slider 56 is supported so as to be slidable in a longitudinal direction of the rail member 51 (a tangential line direction of the curve C) on the rail member 51 in a manner where each roller 61 is rotated between the slider 56 and the rail member 51. Further, as illustrated in FIG. 7, a recessed portion 62 is formed on the vehicle body within which the slider 56 moves so that the slider 56 (the slider fixing member 60) does not engage the vehicle body.

On one of the side wall portions 52, lock holes 52a each formed in a rectangular shape are provided so as to be equally distanced each other in a longitudinal direction of the rail member 51. In this example, eight lock holes 52a are formed (see FIGS. 6 and 7) on the side wall portion 52 provided at the left of the rail member 51 in FIG. 8. Further, on one of the slider side wall portions 58 (in this embodiment, on the slider side wall portion 58 provided at the left of the slider 56 in FIG. 8), a through hole 58a is formed so as to correspond with one of the lock holes 52a formed on the rail member 51.

As illustrated in FIG. 8, a supporting bracket 63 is fixed to the top portion 57 of the slider 56 by screwing. The supporting bracket 63 is formed in an approximately C-shape and arranged so as to open toward the bottom wall portion 53 of the rail member 51. In this configuration, a lock pin 64 is supported by the supporting bracket 63 so as to be slidable in a width direction of the supporting bracket. Specifically, the lock pin 64 is provided so as to protrude outward and face the through hole 58a. The lock pin 64 is provided so as to engage/disengage the through hole 58 in accordance with the movement of the lock pin 64 in an axial direction thereof (in a width direction of the supporting bracket 63).

When the lock pin 64 is inserted into the through hole 58a and one of the lock holes 52a, the slider 56 is prohibited so as not to slide on the rail member 51, at the same time, the position of the striker 13 is determined. When the lock pin 64 is disengaged from the lock hole 52a and the through hole 58a, the slider 56 is permitted to slide on the rail member 51. The lock holes 52a, the lock pin 61 and their surrounding structure form a lock apparatus 70 for prohibit/permit of the slide of the slider 56 on the rail member 51.

As illustrated in FIG. 6, a cable bracket 65 formed in a L-shape is provided within the supporting bracket 63 and fixed to the lock pin 64. One end of the internal wire 32a of the cable 32 is connected to the cable bracket 65. On end of the external wire 32b of the cable 32 is fixed to the top portion 57 of the slider 56 together with the supporting bracket 63. In this configuration, when the release handle connected to the other end of the internal wire 32a of the cable 32 is operated, the internal wire 32a is pulled, accordingly, the lock pin 64 is moved in an axial direction thereof (upper-lower direction) so as to disengage from the trough hole 58a in accordance with the movement of the cable bracket 65.

A base portion of the lock pin is inserted to the torsion spring 67 housed between the supporting brackets 63, and one end of the torsion spring 67 elastically engages the cable bracket 65. The lock pin 64 is normally biased in a direction where one end of the lock pin 64 is inserted into the through hole 58a.

Next, the roller 61 and its surrounding structure will be explained. As illustrated in FIG. 8, each side wall portion 52 includes a recessed portion 71 formed so as to be recessed inwardly in a width direction of the rail member 51.

Further, as illustrated in FIG. 8, each slider side wall portion 58 includes a recessed portion 72 and two projecting portion 73. The recessed portion 72 is formed so as to be recessed outwardly in a width direction of the slider 56, and the projecting portion 73 is formed at each end of the recessed portion 72 (an upper end and a lower end) so as to project toward the recessed portion 71 of the side wall portion 52.

Each roller 61, having an approximate diamond shape cross section, includes two small diameter portions 74 at each end in an axial direction thereof and a large diameter portion 75 formed between the small diameter portions 74. The large diameter portion 75 have a diameter that is larger than a diameter of the small diameter portion 74 in a rotational axis of the roller 61. The roller 61 is supported between the slider 56 and the rail member 51 in a manner where each small diameter portion 74 engages the projecting portion 73 of the slider 56, and the large diameter portion 75 engages the recessed portion 71 of the rail member 51. Because of the recessed portion 72, the roller 61 can rotate without interfering with the slider 56 at the large diameter portion 75. In the same manner as the first embodiment, when the roller 61 is rotated, a moving distance (L1) of the roller 61 relative to the slider 56 is set to be substantially smaller than a moving distance (L) of the rail member 51 relative to the slider 56.

As illustrated in FIG. 8, both recessed portions 71 are formed so as to be symmetrical in a width direction of the rail member 51, and both projecting portions 73 are formed so as to be symmetrical in a width direction of the slider 56. Thus, each roller 61 is supported between the recessed portion 71 and the projecting portion 73 in a manner where each roller 61 is pressed in a width direction of the rail member 51 (slider 56), thus, the movement of each roller 61 in a width direction of the rail member 51 (slider 56) may be restricted.

In this configuration, in the same manner as the first embodiment, the movement of the slider 56 is prohibited/permitted by means of the lock apparatus 70, and the position of the striker 13 is adjusted by adjusting a position of the slider 56 relative to the rail member 51.

As mentioned above, according to the striker device 50 of the second embodiment may provide the following results in addition to that of the first embodiment. In the second embodiment, even though the length of the rail member 51 is longer than that of the slider 56, because the rail member 51 is formed so as to have a smaller cross-sectional area than that of the slider 56, in cross section, and the rail member 51 is arranged within the slide 56 formed so as to have a rectangular cross section, the striker device 50 may achieve downsizing and weight saving.

The embodiments may be modifies as follows.

The shapes of the cross section of the rail member and the slider may be modified. For example, the shapes of the cross section of the rail member and the slider may be modified in a manner where the recessed portion is formed on the bottom portion 22 of the rail member so that the large diameter portion 44 of the roller 27, which is arranged with corresponding its axial line to a width direction of the rail member 11, contacts the recessed portion and where the projecting portion is formed at an appropriate place of the slider so that the small diameter portion 45 of the roller 27 contacts the projecting portion. Further, at least one roller 27 may be provided between the rail member 11 and the slider 12 as long as the roller 27 is stably supported between the recessed portion and the projecting portion.

Three or more rollers 27 may be provided between the rail member 11 and the slider 12 as long as the rollers 27 is stably supported between the recessed portion and the projecting portion in a manner where each roller 27 is pressed inwardly. In this case, the axial line of the roller 27 may be inclined relative to the bottom portion 22, and further, the plural rollers 27 may not be arranged in a manner where axis lines of the rollers 27 are paralleled each other.

The principles, preferred embodiment and mode of operation of the present invention have been described in the foregoing specification. However, the invention which is intended to be protected is not to be construed as limited to the particular embodiments disclosed. Further, the embodiments described herein are to be regarded as illustrative rather than restrictive. Variations and changes may be made by others, and equivalents employed, without departing from the sprit of the present invention. Accordingly, it is expressly intended that all such variations, changes and equivalents which fall within the spirit and scope of the present invention as defined in the claims, be embraced thereby.

1. A seat reclining apparatus for a vehicle, comprising:
a rail member formed in a straight shape and adapted to be attached to the vehicle so as to be aligned approximately along a curve described by a pivotal movement of a seat back;
a slider attached to the rail member so as to be slidable;
a lock apparatus for regulating/permitting the slider to slide on the rail member;
a striker formed so as to include a first end portion, a second end portion and a connecting portion connecting the first end portion to the second end portion, the first end portion and the second end portion being connected to the slider; and
a rotating member provided between the rail member and the slider and including a large diameter portion and a small diameter portion, the large diameter portion engaging the rail member along a longitudinal direction of the rail member, and the small diameter portion engaging the slider along a longitudinal direction of the rail member; wherein
the striker adapted to engage a lock member attached to the seat back in order to maintain an angle of the seat back.

2. The seat reclining apparatus according to claim 1, wherein
the rail member includes a recessed portion to which the large diameter portion of the rotating member is contacted, and
the slider includes a projecting portion to which the small diameter portion is contacted.

3. The seat reclining apparatus according to claim 2, wherein
a plurality of the recessed portions are formed on the rail member so as to face each other in a width direction of the rail member.

4. The seat reclining apparatus according to claim 2, wherein
a plurality of the projecting portions are formed on the slider so as to face each other in a width direction of the slider.

5. The seat reclining apparatus according to claim 2, wherein
a plurality of the recessed portions are formed on the rail member so as to face each other in a width direction of the rail member, and
a plurality of the projecting portions are formed on the slider so as to face each other in a width direction of the slider.

6. The seat reclining apparatus according to claim 2, wherein,
the rail member is formed so as to have a vehicle side attaching surface, side surface portions, inclined surfaces and vertical surface portions in its cross section, the side surface portions facing each other, the vehicle side attaching surface, at which the rail member is attached to the vehicle, connecting one of the side surface portions to the other of the side surface portions at lower ends thereof, each inclined surface being formed so as to extend inwardly from an upper end of the side surface portion, and each vertical surface portion being formed so as to extend vertically toward the bottom portion from an end of each inclined surface,
the slider is formed so as to have a striker attaching surface, slider inclined surfaces and U-shaped portions in its cross section, the striker attaching surface, to which the striker is attached, arranged so as to be parallel with the vehicle side attaching surface, each slider inclined surface formed so as to extend vertically and inwardly from each end of the top portion, and each U-shaped portion being formed at each lower end of the slider inclined surface so as to extend in parallel with the vertical surface portion of the rail member and formed so as to enclose the vertical surface portion, and
the recessed portion is formed on each side surface portion of the rail member, and
the projecting portion is formed on each U-shaped portion in a manner where one corner of the U-shaped portion, which faces the side surface portion of the slider member, projects toward the recessed portion of the rail member.

7. The seat reclining apparatus according to claim 3, wherein,
the rail member is formed so as to have a vehicle side attaching surface, side surface portions, inclined surfaces and vertical surface portions in its cross section, the side surface portions facing each other, the vehicle side attaching surface, at which the rail member is attached to the vehicle, connecting one of the side surface portions to the other of the side surface portions at lower ends thereof, each inclined surface being formed so as to extend inwardly from an upper end of the side surface portion, and each vertical surface portion being formed so as to extend vertically toward the bottom portion from an end of each inclined surface,
the slider is formed so as to have a striker attaching surface, slider inclined surfaces and U-shaped portions in its cross section, the striker attaching surface, to which the striker is attached, arranged so as to be parallel with the vehicle side attaching surface, each slider inclined surface formed so as to extend vertically and inwardly from each end of the top portion, and each U-shaped portion being formed at each lower end of the slider inclined surface so as to extend in parallel with the vertical surface portion of the rail member and formed so as to enclose the vertical surface portion, and
the recessed portion is formed on each side surface portion of the rail member, and
the projecting portion is formed on each U-shaped portion in a manner where one corner of the U-shaped portion, which faces the side surface portion of the slider member, projects toward the recessed portion of the rail member.

8. The seat reclining apparatus according to claim 4, wherein,
the rail member is formed so as to have a vehicle side attaching surface, side surface portions, inclined surfaces and vertical surface portions in its cross section, the side surface portions facing each other, the vehicle side attaching surface, at which the rail member is attached to the vehicle, connecting one of the side surface portions to the other of the side surface portions at lower ends thereof, each inclined surface being formed so as to extend inwardly from an upper end of the side surface portion, and each vertical surface portion being formed so as to extend vertically toward the bottom portion from an end of each inclined surface,
the slider is formed so as to have a striker attaching surface, slider inclined surfaces and U-shaped portions in its cross section, the striker attaching surface, to which the striker is attached, arranged so as to be parallel with the vehicle side attaching surface, each slider inclined surface formed so as to extend vertically and inwardly from each end of the top portion, and each U-shaped portion being formed at each lower end of the slider inclined surface so as to extend in parallel with the vertical surface portion of the rail member and formed so as to enclose the vertical surface portion, and
the recessed portion is formed on each side surface portion of the rail member, and
the projecting portion is formed on each U-shaped portion in a manner where one corner of the U-shaped portion, which faces the side surface portion of the slider member, projects toward the recessed portion of the rail member.

9. The seat reclining apparatus according to claim 5, wherein,
the rail member is formed so as to have a vehicle side attaching surface, side surface portions, inclined surfaces and vertical surface portions in its cross section, the side surface portions facing each other, the vehicle side attaching surface, at which the rail member is attached to the vehicle, connecting one of the side surface portions to the other of the side surface portions at lower ends thereof, each inclined surface being formed so as to extend inwardly from an upper end of the side surface portion, and each vertical surface portion being formed so as to extend vertically toward the bottom portion from an end of each inclined surface,
the slider is formed so as to have a striker attaching surface, slider inclined surfaces and U-shaped portions in its cross section, the striker attaching surface, to which the striker is attached, arranged so as to be parallel with the vehicle side attaching surface, each slider inclined surface formed so as to extend vertically and inwardly from each end of the top portion, and each U-shaped portion being formed at each lower end of the slider inclined surface so as to extend in parallel with the vertical surface portion of the rail member and formed so as to enclose the vertical surface portion, and
the recessed portion is formed on each side surface portion of the rail member, and
the projecting portion is formed on each U-shaped portion in a manner where one corner of the U-shaped portion, which faces the side surface portion of the slider member, projects toward the recessed portion of the rail member.

10. The seat reclining apparatus according to claim 2, wherein,
the rail member is formed so as to have a vehicle side attaching surface, at which the rail member is attached to the vehicle, and side wall portions in its cross section, the side wall portions facing each other, the vehicle side attaching surface connecting one of the side wall portions to the other of the side wall portions at lower ends thereof, and
the slider is formed in a rectangular shape so as to have a striker attaching surface, slider side wall portions, flat portions and a slider fixing member in its cross section, the striker attaching surface, to which the striker is attached, arranged so as to be parallel with the vehicle side attaching surface, each slider side wall portion formed so as to extend vertically from each end of the striker attaching surface, each flat portion extending inwardly from a lower end of each slider side wall portion, the slider fixing member fixed to each flat portion so as to connect one of the flat portions to the other of the flat portions, and
the recessed portion is formed on each side wall portion of the rail member so as to face each other, and
the projecting portion is formed on each slider side wall portions of the slider so as to project toward the recessed portion of the rail member.

11. The seat reclining apparatus according to claim 3, wherein,
the rail member is formed so as to have a vehicle side attaching surface, at which the rail member is attached to the vehicle, and side wall portions in its cross section, the side wall portions facing each other, the vehicle side attaching surface connecting one of the side wall portions to the other of the side wall portions at lower ends thereof, and
the slider is formed in a rectangular shape so as to have a striker attaching surface, slider side wall portions, flat portions and a slider fixing member in its cross section, the striker attaching surface, to which the striker is attached, arranged so as to be parallel with the vehicle side attaching surface, each slider side wall portion formed so as to extend vertically from each end of the striker attaching surface, each flat portion extending inwardly from a lower end of each slider side wall portion, the slider fixing member fixed to each flat portion so as to connect one of the flat portions to the other of the flat portions, and
the recessed portion is formed on each side wall portion of the rail member so as to face each other, and
the projecting portion is formed on each slider side wall portions of the slider so as to project toward the recessed portion of the rail member.

12. The seat reclining apparatus according to claim 4, wherein,
the rail member is formed so as to have a vehicle side attaching surface, at which the rail member is attached to the vehicle, and side wall portions in its cross section, the side wall portions facing each other, the vehicle side attaching surface connecting one of the side wall portions to the other of the side wall portions at lower ends thereof, and
the slider is formed in a rectangular shape so as to have a striker attaching surface, slider side wall portions, flat portions and a slider fixing member in its cross section, the striker attaching surface, to which the striker is attached, arranged so as to be parallel with the vehicle side attaching surface, each slider side wall portion formed so as to extend vertically from each end of the striker attaching surface, each flat portion extending inwardly from a lower end of each slider side wall portion, the slider fixing member fixed to each flat portion so as to connect one of the flat portions to the other of the flat portions, and
the recessed portion is formed on each side wall portion of the rail member so as to face each other, and
the projecting portion is formed on each slider side wall portions of the slider so as to project toward the recessed portion of the rail member.

13. The seat reclining apparatus according to claim 5, wherein,
the rail member is formed so as to have a vehicle side attaching surface, at which the rail member is attached to the vehicle, and side wall portions in its cross section, the side wall portions facing each other, the vehicle side attaching surface connecting one of the side wall portions to the other of the side wall portions at lower ends thereof, and
the slider is formed in a rectangular shape so as to have a striker attaching surface, slider side wall portions, flat portions and a slider fixing member in its cross section, the striker attaching surface, to which the striker is attached, arranged so as to be parallel with the vehicle side attaching surface, each slider side wall portion formed so as to extend vertically from each end of the striker attaching surface, each flat portion extending inwardly from a lower end of each slider side wall portion, the slider fixing member fixed to each flat portion so as to connect one of the flat portions to the other of the flat portions, and
the recessed portion is formed on each side wall portion of the rail member so as to face each other, and
the projecting portion is formed on each slider side wall portions of the slider so as to project toward the recessed portion of the rail member.

14. The seat reclining apparatus according to claims 2, wherein
the large diameter portion of the rotating member includes a first curved surface formed in a circular arc shape viewed in a direction that is perpendicular to a rotational axis of the rotating member, the small diameter portion of the rotating member includes a second curved surface formed in a circular arc shape viewed in a direction that is perpendicular to a rotational axis of the rotating member,
a curvature radius of the recessed portion, to which the large diameter portion is contacted, is set to be larger than a curvature radius of the first curved surface, and
a curvature radius of the projecting portion, to which the small diameter portion is contacted, is set to be smaller than a curvature radius of the second curved surface.

15. The seat reclining apparatus according to claim 3, wherein
the large diameter portion of the rotating member includes a first curved surface formed in a circular arc shape viewed in a direction that is perpendicular to a rotational axis of the rotating member, the small diameter portion of the rotating member includes a second curved surface formed in a circular arc shape viewed in a direction that is perpendicular to a rotational axis of the rotating member,
a curvature radius of the recessed portion, to which the large diameter portion is contacted, is set to be larger than a curvature radius of the first curved surface, and
a curvature radius of the projecting portion, to which the small diameter portion is contacted, is set to be smaller than a curvature radius of the second curved surface.

16. The seat reclining apparatus according to claim 4, wherein
the large diameter portion of the rotating member includes a first curved surface formed in a circular arc shape viewed in a direction that is perpendicular to a rotational axis of the rotating member, the small diameter portion of the rotating member includes a second curved surface formed in a circular arc shape viewed in a direction that is perpendicular to a rotational axis of the rotating member,
a curvature radius of the recessed portion, to which the large diameter portion is contacted, is set to be larger than a curvature radius of the first curved surface, and
a curvature radius of the projecting portion, to which the small diameter portion is contacted, is set to be smaller than a curvature radius of the second curved surface.

17. The seat reclining apparatus according to claim 5, wherein
the large diameter portion of the rotating member includes a first curved surface formed in a circular arc shape viewed in a direction that is perpendicular to a rotational axis of the rotating member, the small diameter portion of the rotating member includes a second curved surface formed in a circular arc shape viewed in a direction that is perpendicular to a rotational axis of the rotating member,
a curvature radius of the recessed portion, to which the large diameter portion is contacted, is set to be larger than a curvature radius of the first curved surface, and
a curvature radius of the projecting portion, to which the small diameter portion is contacted, is set to be smaller than a curvature radius of the second curved surface.

18. The seat reclining apparatus according to claim 6, wherein
the large diameter portion of the rotating member includes a first curved surface formed in a circular arc shape viewed in a direction that is perpendicular to a rotational axis of the rotating member, the small diameter portion of the rotating member includes a second curved surface formed in a circular arc shape viewed in a direction that is perpendicular to a rotational axis of the rotating member,
a curvature radius of the recessed portion, to which the large diameter portion is contacted, is set to be larger than a curvature radius of the first curved surface, and
a curvature radius of the projecting portion, to which the small diameter portion is contacted, is set to be smaller than a curvature radius of the second curved surface.

19. The seat reclining apparatus according to claim 7, wherein
the large diameter portion of the rotating member includes a first curved surface formed in a circular arc shape viewed in a direction that is perpendicular to a rotational axis of the rotating member, the small diameter portion of the rotating member includes a second curved surface formed in a circular arc shape viewed in a direction that is perpendicular to a rotational axis of the rotating member,
a curvature radius of the recessed portion, to which the large diameter portion is contacted, is set to be larger than a curvature radius of the first curved surface, and
a curvature radius of the projecting portion, to which the small diameter portion is contacted, is set to be smaller than a curvature radius of the second curved surface.

20. The seat reclining apparatus according to claim 8, wherein
the large diameter portion of the rotating member includes a first curved surface formed in a circular arc shape viewed in a direction that is perpendicular to a rotational axis of the rotating member, the small diameter portion of the rotating member includes a second curved surface formed in a circular arc shape viewed in a direction that is perpendicular to a rotational axis of the rotating member,
a curvature radius of the recessed portion, to which the large diameter portion is contacted, is set to be larger than a curvature radius of the first curved surface, and
a curvature radius of the projecting portion, to which the small diameter portion is contacted, is set to be smaller than a curvature radius of the second curved surface.
